(19) United States
(12) Patent Application Publication
(10) Pub. No.: US 2025/0233635 A1
(43) Pub. Date: Jul. 17, 2025

(54) MIMO EVM MEASUREMENT USING THE PSEUDO-INVERSE

(71) Applicant: Lenovo (Singapore) Pte. Ltd., New Tech Park (SG)

(72) Inventor: Colin Frank, Park Ridge, IL (US)

(21) Appl. No.: 18/703,684

(22) PCT Filed: Oct. 24, 2022
(86) PCT No.: PCT/IB2022/060204

§ 371 Date: Apr. 22, 2024

Related U.S. Application Data
(60) Provisional application No. 63/271,076, filed on Oct. 22, 2021.

(51) Int. Cl. H04B 7/06

(52) U.S. Cl. CPC H04B 7/0652; H04B 7/063; H04B 7/0634

(57) ABSTRACT

Apparatuses, methods, and systems are disclosed for multiple-input, multiple-output (“MIMO”) error vector magnitude (“EVM”) measurement using the pseudo-inverse. One method includes receiving, from a transmitter, a multiple-layer transmission signal via a propagation channel that does not have full rank, where the multiple-layer transmission signal is received using a MIMO receiver. The method includes calculating an EVM of the transmitter using the pseudo-inverse of the channel matrix, where the pseudo-inverse that is derived using a reciprocal of non-zero diagonal elements.

### CROSS-REFERENCE TO RELATED APPLICATIONS

This application claims priority to U.S. Provisional Patent Application No. 63/271,076 entitled “MIMO EVM MEASUREMENT USING THE PSEUDO-INVERSE” and filed on 22 Oct. 2021 for Colin Frank, which application is incorporated herein by reference.

### FIELD

The subject matter disclosed herein relates generally to wireless communications and more particularly relates to techniques for handling Error Vector Magnitude (“EVM”) for a multiple-layer transmission over a propagation channel lacking a full rank.

### BACKGROUND

In wireless communication devices, phase and amplitude distortion created by the power amplifier directly affects the quality of the communication. The most significant measurement for analyzing power amplifier performance in the latest communication system protocols is the EVM. This is a measure of modulation accuracy, or how well the power amplifier is transmitting information, represented by the varying phase and amplitude of a radio frequency (“RF”) signal. EVM measurements lend insight into the communication link and are a key measure of transmitter performance.

### BRIEF SUMMARY

Disclosed are procedures related to multiple-input, multiple-output (“MIMO”) EVM measurement using the pseudo-inverse of the channel matrix. Said procedures may be implemented by apparatus, systems, methods, or computer program products.

One method at an evaluator device includes receiving, from a transmitting device, a multiple-layer MIMO signal via a propagation channel lacking full rank; and calculating an EVM of the transmitting device based at least in part on the received multiple-layer MIMO signal and using a pseudo-inverse of a channel matrix derived using a reciprocal of non-zero diagonal elements of a diagonal matrix of the singular values of the channel matrix.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for MIMO EVM measurement using the pseudo-inverse;

FIG. 2 is a block diagram illustrating one embodiment of a Third Generation Partnership Project (“3GPP”) New Radio (“NR”) protocol stack;

FIG. 3 is a diagram illustrating one embodiment of a communication arrangement for calculating an EVM of a transmitter;

FIG. 4 is a diagram illustrating one embodiment of procedure for calculating an EVM of a transmitting device;

FIG. 5 is a block diagram illustrating one embodiment of a user equipment apparatus that may be used for MIMO EVM measurement using the pseudo-inverse;

FIG. 6 is a block diagram illustrating one embodiment of a network apparatus that may be used for MIMO EVM measurement using the pseudo-inverse; and

FIG. 7 is a flowchart diagram illustrating one embodiment of a method for MIMO EVM measurement using the pseudo-inverse.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for calculating an EVM of a transmitter. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

The problem solved is the defining the User Equipment (“UE”) transmit EVM for a multiple-layer MIMO transmission. Due to leakage between the antennas within the UE, it may not be possible to measure the EVM for the antenna connectors independently even in the case that the antenna precoder is the identity matrix. If the EVM is measured without addressing the leakage between the two antennas, the EVM requirement cannot be met.

The purpose of the EVM requirement on the transmitter is to limit the noise floor at the receiver that is due to transmitter noise. For multiple-layer MIMO transmissions, the objective of the EVM requirement is to limit the noise/error floor due to transmitter noise for each MIMO layer. Thus, the relationship between the per antenna connector EVM at the UE antenna connectors and the per-layer EVM at the gNB should be investigated.

In some embodiments, a linear zero-forcing MIMO equalizer (also referred to herein as linear zero-forcing MIMO receiver) is used to determine the transmitter EVM for a multiple-layer transmission. In some embodiments, the EVM may be specified for each MIMO layer. In other embodiments, the EVM may be specified for each antenna connector.

The present disclosure describes using a MIMO equalizer which uses a definition of the pseudo-inverse of the channel matrix which can be used to calculate the EVM of a transmitter where the propagation channel does not have full rank.

Described herein is the relationship between the EVM at the transmitter antenna connectors and the per-layer EVM at the receiver, e.g., in the case that the number of transmit and receive antennas are the same. Solutions are described on how the EVM can be defined and specified for the case where the propagation channel does not have full rank. While the below examples and descriptions may use a UE transmitter when describing the transmitting device, in other examples the transmitting device may be a gNB or other base station; thus, the transmitter EVM determined according to the below descriptions may be a UE transmitter EVM, a gNB transmitter EVM, or transmitter EVM of another transmitter.

In various embodiments, a transmitting device generates a multiple-layer transmission signal for MIMO and transmits the generated multiple-layer transmission signal (to an evaluation device) via a propagation channel using a transmitter. The evaluation device measures the transmitted multiple-layer transmission signal using a MIMO receiver and calculates an EVM of the transmitter, according to the below descriptions.

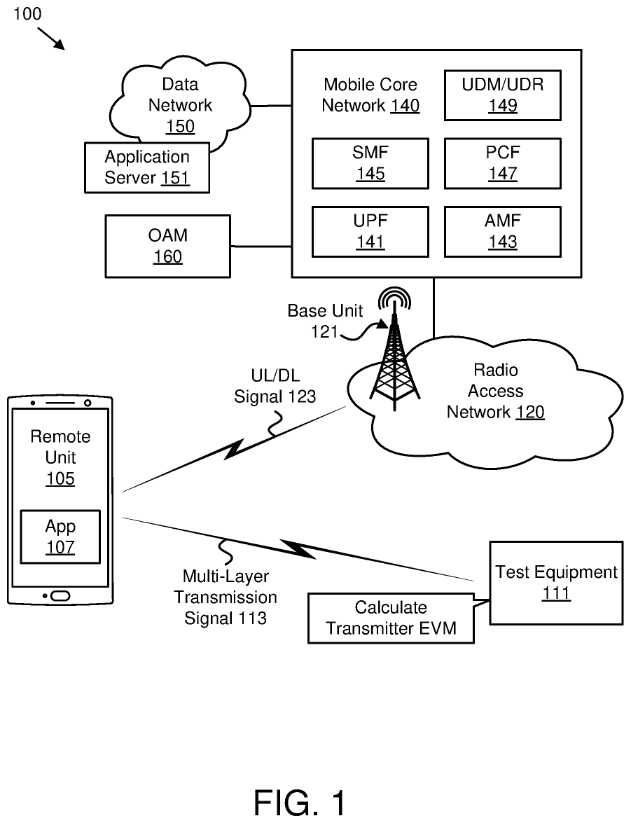

FIG. 1 depicts a wireless communication system 100 for MIMO EVM measurement using the pseudo-inverse, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication networks, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication (not shown in FIG. 1). Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframes, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, abase station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

The Operations, Administration and Maintenance (“OAM”) 160 is involved with the operating, administering, managing, and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM 160 may also be involved with provisioning, i.e., the setting up of the user accounts, devices, and services.

While FIG. 1 depicts components of a 5G RAN and a 5G core network, the described embodiments for MIMO EVM measurement using the pseudo-inverse apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems MIMO EVM measurement using the pseudo-inverse.

In the following descriptions, the term “gNB” is used for the base station/base unit, but it is replaceable by any other radio access node, e.g., RAN node, eNB, Base Station (“BS”), Access Point (“AP”), ng-eNB, etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems calculating an EVM of a transmitter (e.g., UE transmitter or gNB transmitter).

EVM is a measure of modulation accuracy, or how well the power amplifier in the remote unit 105 is transmitting information, represented by the varying phase and amplitude of an RF signal. As such, the remote unit 105 may send a transmission signal 113 (e.g., a multiple-layer transmission) to a test equipment 111. Upon receiving the transmission signal 113, the test equipment 111 calculates a transmitter EVM for multiple-layer transmission. Note that in other embodiments, the remote unit 105 may transmit to the base unit 121, where the base unit 121 calculates a transmitter EVM for multiple-layer transmission.

In evaluating the EVM where the propagation channel does not have full rank, several aspects are considered including whether the EVM can be defined using conventional processes. If not achievable, then using such a method for defining the transmitter EVM might be of questionable value since the transmitter EVM could not be mapped to a corresponding noise floor at the receiver. However, for the MIMO receivers described herein, the EVM is independent of the propagation channel between the transmitting device and the evaluator device.

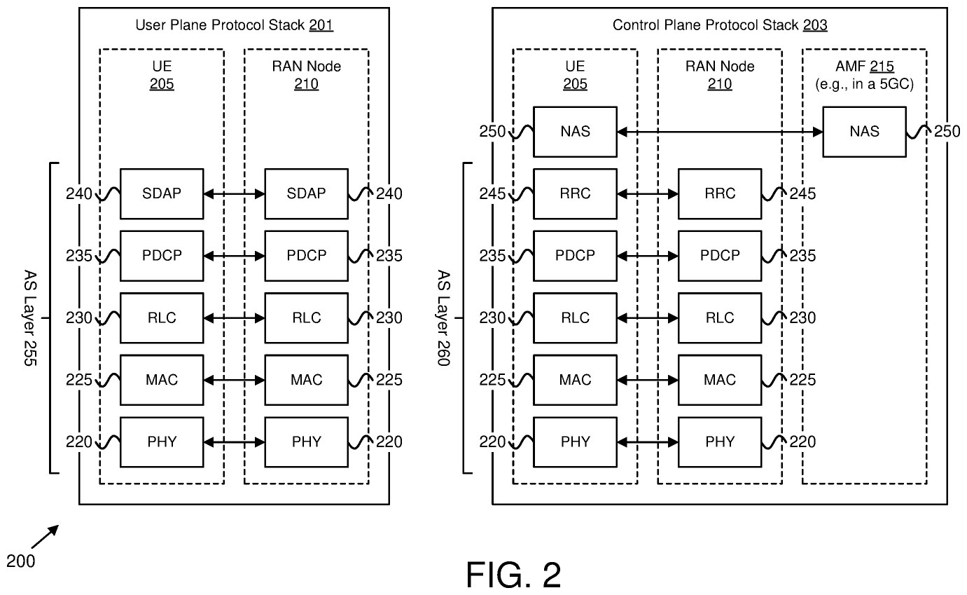

FIG. 2 depicts an NR protocol stack 200, according to embodiments of the disclosure. While FIG. 2 shows the UE 205, the RAN node 210 and an AMF 215 in a 5G core network (“5GC”), these are representatives of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

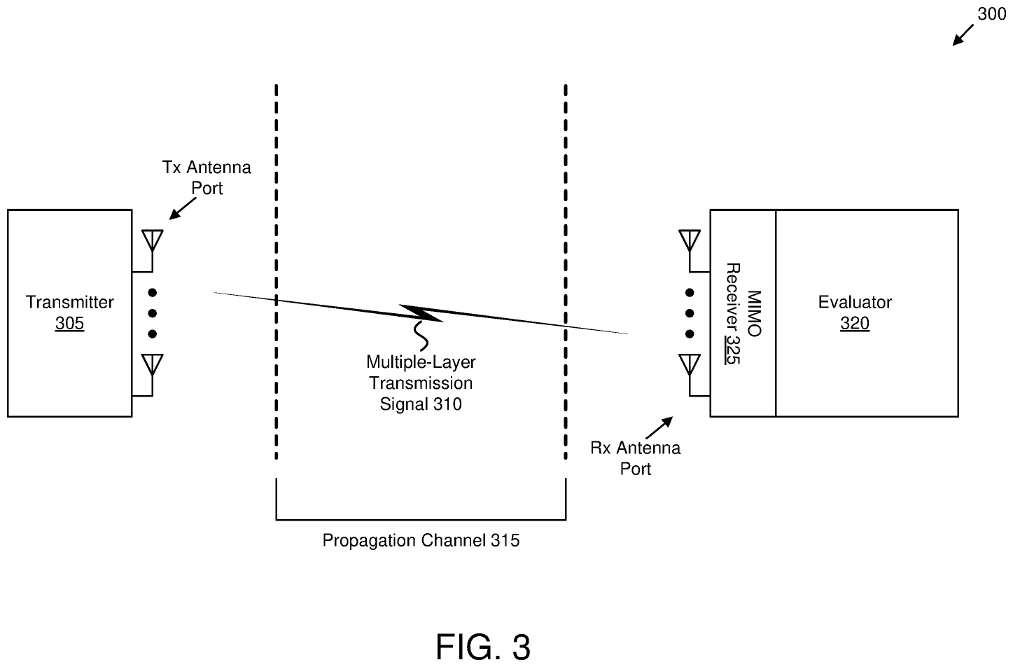

FIG. 3 is a block diagram illustrating one embodiment of a communication arrangement 300 for calculating an EVM of a transmitter. The arrangement 300 involves a transmitter 305 and an evaluator 320 for calculating an EVM of the transmitter 305. As depicted, the transmitter 305 comprises a plurality of antennas. In some embodiments, the plurality of transmitter antennas (“Tx antennas”) are arranged into one or more antenna ports (i.e., Tx antenna ports), each antenna port comprising multiple antennas and with an antenna connector for each antenna. In certain embodiments, the transmitter 305 is one embodiment of the remote unit 105 (or the UE 205) and the evaluator 320 is an embodiment of the test equipment 111, or the base unit 121 (or RAN node 210), or another remote unit 105 (or another UE 205). However, in other embodiments the transmitter 305 may be an embodiment of the base unit 121 (or RAN node 210), wherein the evaluator 320 is an embodiment of the test equipment 111, another base unit 121 (or another RAN node 210), or a UE 205.

The transmitter 305 generates a multiple-layer transmission signal for MIMO and transmits the multiple-layer transmission signal 310 (e.g., a multiple-layer MIMO signal) to the evaluator 320 via a propagation channel 315. The evaluator 320 measures the multiple-layer transmission signal 310 using a MIMO receiver 325 (e.g., by taking the pseudo-inverse of the channel matrix) and calculates an EVM of the transmitter 305, according to the below descriptions. Note that the MIMO receiver 325 of the evaluator 320 may comprise a plurality of antennas. In some embodiments, the plurality of receiver antennas (“Rx antennas”) are arranged into one or more antenna ports (i.e., Rx antenna ports), each antenna port comprising multiple antennas and with an antenna connector for each antenna. Importantly, to improve EVM accuracy, the multiple-layer transmission signal 310 may be received by the MIMO receiver 325 using the same number of antennas as used by the transmitter 305. For example, the Rx antenna port may comprise the same number of antennas as comprises the transmitter antenna port.

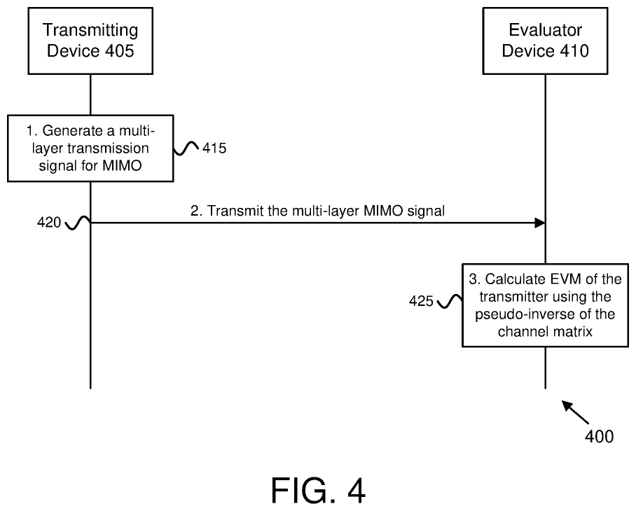

FIG. 4 depicts a procedure 400 for calculating an EVM of a transmitting device 405, according to embodiments of the disclosure. The procedure 400 involves the transmitting device 405 (e.g., an implementation of the transmitter 305) and an evaluator device 410 (e.g., an implementation of the evaluator 320).

At Step 1, the transmitting device 405 generates a multiple-layer signal for MIMO transmission (see block 415). At Step 2, the transmitting device 405 transmits the generated multiple-layer MIMO signal to the evaluation device 410, e.g., via a propagation channel (see messaging 420). At Step 3, the evaluation device 410 receives the transmitted multiple-layer MIMO signal (e.g., using a pseudo-inverse receiver that performs a pseudo-inverse operation to the effective channel matrix) and calculates an EVM of the transmitter based at least in part on the received multiple-layer MIMO signal (see block 425).

In various embodiments, the pseudo-inverse receiver may be used to define and measure the EVM for two-layer transmissions. The below descriptions point out some fundamental issues with the conventional pseudo-inverse definition. As discussed below, the pseudo-inverse cannot be defined or computed as

$${\tilde{H}}^{+} = {( {\tilde{H}}^{H} \tilde{H} )}^{- 1} {\tilde{H}}^{H}$$

when the channel does not have full rank. Furthermore, the MIMO layers cannot be separated using the pseudo-inverse when the channel does not have full rank. Alternative definitions of the pseudo-inverse are described herein which address these issues.

Regarding EVM for Two-Layer Transmission, previous schemes have proposed that the pseudo-inverse be used in the definition and measurement of EVM for two-layer transmission. The effective channel matrix may be given by

$$\tilde{H} = HP = [ \begin{matrix}{\tilde{h}}_{0 , 0} & {\tilde{h}}_{0 , 1} \\ {\tilde{h}}_{1 , 0} & {\tilde{h}}_{1 , 1}\end{matrix} ]$$

where H is the 2×2 channel matrix and P is the precoding matrix. It has been proposed that the zero-forcing MIMO equalizer is defined using the pseudo-inverse defined as

$${G}_{Z F} = {\tilde{H}}^{+} = {( {\tilde{H}}^{H} \tilde{H} )}^{- 1} {\tilde{H}}^{H} .$$

where \tilde{H}^{H} is the Hermitian transpose of the effective channel matrix \tilde{H}.

A few observations can be made on the use of the pseudo-inverse for measuring EVM.

Observation 1: If a square matrix \tilde{H} has full rank, then \tilde{H}⁺=\tilde{H}⁻¹, and the pseudo-inverse is not needed.

Observation 2: If a square matrix \tilde{H} does not have full rank, then \tilde{H}^{H}\tilde{H} does not have full rank and the inverse (\tilde{H}^{H}\tilde{H})⁻¹ does not exist. As a result, if \tilde{H} does not have full rank, then the pseudo-inverse cannot be defined or computed as

$${\tilde{H}}^{+} = {( {\tilde{H}}^{H} \tilde{H} )}^{- 1} {\tilde{H}}^{H} .$$

Accordingly, if the pseudo-inverse were to be used, it would be necessary to define it in some other manner such as in terms of the singular value decomposition of \tilde{H}.

Observation 3: If the square matrix \tilde{H} does not have full rank, then it is not possible to separate the MIMO layers using the pseudo-inverse or any other linear receiver and the EVM requirement will be failed.

With respect to Observation 3, note that if \tilde{H} does not have full rank, then multiplication by the pseudo-inverse does not yield the identity matrix; that is

$${\tilde{H}}^{+} \tilde{H} \neq I ,$$

and as a result, the pseudo-inverse \tilde{H}⁺ cannot be used to separate the MIMO layers. To demonstrate, let y denote the signal received given by

$$y = \tilde{H} ( x + n )$$

where x is the transmitted data vector, n is the transmitter noise vector, and \tilde{H} has dimension 2×2. Furthermore, let the singular value decomposition of \tilde{H} be given by

$$\tilde{H} = U \sum {V}^{H} ,$$

where U and V are 2×2 complex unitary matrices with the columns of U being the eigenvectors of the effective channel matrix, where V^{H} is the Hermitian transpose of the matrix V, and Σ is a square diagonal matrix with the eigenvalues of the effective channel matrix along the diagonal, for which the diagonal elements are real and non-negative. As described below, it is shown that if the pseudo-inverse \tilde{H}⁺ is defined as

$${\tilde{H}}^{+} = V {\sum }^{+} {U}^{H} ,$$

and \tilde{H} does not have full rank, then the resulting data estimate \hat{x} is given by

$$x = {H}^{+} y = {v}_{1} {v}_{1}^{H} ( x + n ) = ( {v}_{1}^{*} x ) {v}_{1} + ( {v}_{1}^{*} n ) {v}_{1}$$

where v₁ is the right singular vector belonging to V for which the corresponding singular value is non-zero. Thus, in the case that \tilde{H} does not have full rank, the expected value of the estimate is given by

$$E ( \hat{x} \vert x ) = ( {v}_{1}^{H} x ) {v}_{1}$$

which is the projection of the data vector x onto the right singular vector v₁.

As described below, even if there is no transmitter noise so that n=0, the EVM for the estimate

$$\hat{x} = {\tilde{H}}^{+} y$$

when \tilde{H} does not have full rank is no less than 71%, so in this case the EVM requirement fails.

Observation 4: If \tilde{H} does not have full rank and G_{ZF}=\tilde{H}⁺=VΣ⁺U^{H} is used, the resulting EVM will be no less than 71%.

In summary, if the square matrix \tilde{H} does not have full rank, the pseudo-inverse cannot be defined and computed as

$${\tilde{H}}^{+} = {( {\tilde{H}}^{H} \tilde{H} )}^{- 1} {\tilde{H}}^{H}$$

because (\tilde{H}^{H}\tilde{H})⁻¹ does not exist. Furthermore, if \tilde{H} does not have full rank, the two layers of data cannot be separated with the pseudo-inverse or any other linear receiver. If the pseudo-inverse is used in this case, the EVM will be no less than 71%.

As the result of the above, the following solutions are defined.

Solution 1: If \tilde{H} has full rank, then G_{ZF}=\tilde{H}⁻¹. If \tilde{H} has does not have full rank, the two layers cannot be separated and the EVM requirement is failed.

In order to use the pseudo-inverse when \tilde{H} does not have full rank, the following alternative solution may be utilized.

Solution 2: The zero-forcing receiver is defined as G_{ZF}=\tilde{H}⁺ where the singular value decomposition for \tilde{H} is given by

$$\tilde{H} = U \sum {V}^{H} ,$$

the pseudo-inverse \tilde{H}⁺ is defined as

$${\tilde{H}}^{+} = V {\sum }^{+} {U}^{H} ,$$

U^{H} is the Hermitian transpose of a unitary matrix U, and Σ⁺ is derived from Σ by taking the reciprocal of the non-zero diagonal elements and leaving the zero elements in place.

Regarding EVM for 2-Layer MIMO with a rank deficient channel, in the case that the square matrix \tilde{H} does not have full rank, the pseudo-inverse can be expressed in terms of the singular value decomposition of \tilde{H} which is given by

$$\tilde{H} = U \sum {V}^{H} ,$$

where U and V are unitary matrices and Σ is a diagonal matrix for which the diagonal elements are real and non-negative. If \tilde{H} has dimension 2×2 and rank 1 then \tilde{H} can be expressed as

$$\tilde{H} = U [ \begin{matrix}λ & 0 \\ 0 & 0\end{matrix} ] {V}^{H}$$

where λ is real and positive, and where V^{H} is the Hermitian transpose of a unitary matrix V. For this example, the pseudo-inverse is given by

$${\tilde{H}}^{+} = V {\sum }^{+} {U}^{H} = V [ \begin{matrix}{λ}^{- 1} & 0 \\ 0 & 0\end{matrix} ] {U}^{H}$$

In the absence of receiver noise, the received signal is given by

$$y = \tilde{H} ( x + n )$$

where x is the transmitted data and n is the transmitter noise. Multiplication by the pseudo-inverse yields the data estimate

$$\begin{matrix}\hat{x} = \tilde{H} + y = V [ \begin{matrix}{λ}^{- 1} & 0 \\ 0 & 0\end{matrix} ] {U}^{*} U [ \begin{matrix}λ & 0 \\ 0 & 0\end{matrix} ] {V}^{H} ( x + n ) \\ = V [ \begin{matrix}1 & 0 \\ 0 & 0\end{matrix} ] {V}^{H} ( x + n ) , \\ = {v}_{1} {v}_{1}^{H} ( x + n )\end{matrix}$$

where v₁ is the first column of V. The resulting estimate of the data vector x can be expressed as

$$x = ( {v}_{1}^{H} x ) {v}_{1} + ( {v}_{1}^{H} n ) {v}_{1}$$

where (v₁^{H}x) v₁ is the projection of the data vector x onto the vector v₁. The expected value of the estimate given by

$$E ( \hat{x} \vert x ) = ( {v}_{1}^{H} x ) {v}_{1}$$

which is equal to x if and only if x=v₁. Finally, if the data vector x has mean and covariance given by

$$E ( x ) = 0 and E ( x {x}^{H} ) = [ \begin{matrix}1 / 2 & 0 \\ 0 & 1 / 2\end{matrix} ] ,$$

then E(|x|²)=1, and

$$E ( {[ \hat{x} - x ]}^{2} ) = E ( {\vert ( {v}_{1}^{H} x ) {v}_{1} - x \vert}^{2} ) = E ( {v}_{1}^{H} ( {x}^{H} {v}_{1} {v}_{1}^{H} x ) {v}_{1} - {v}_{1}^{H} {x}^{H} {v}_{1} x - {x}^{H} {v}_{1}^{H} x {v}_{1} + {x}^{H} x ) = \frac{1}{2} - \frac{1}{2} - \frac{1}{2} + 1 = \frac{1}{2} .$$

As a result, even if there is no transmitter noise so that n=0, the mean-square error of the estimate

$$\hat{x} = {\tilde{H}}^{+} y$$

is equal to

$$M S E = E ( {[ \hat{x} - x ]}^{2} ) = \frac{1}{2}$$

and the EVM is given

$$EVM = 100 \sqrt{M S E} = 100 \sqrt{0.5} = 71 \% .$$

It has been proposed that the pseudo-inverse be used in the definition and measurement of EVM for two-layer transmission. However, in this disclosure, it has been observed that if the channel matrix \tilde{H} does not have full rank, then \tilde{H}^{H}\tilde{H} does not have full rank and the pseudo-inverse cannot be defined as

$${\tilde{H}}^{+} = {( {\tilde{H}}^{H} \tilde{H} )}^{- 1} {\tilde{H}}^{H}$$

Furthermore, it has been shown, that if \tilde{H} does not have full rank, then the MIMO layers cannot be separated using the pseudo-inverse or any other linear receiver. Based on these observations, the following solutions are described.

Solution 1: If \tilde{H} has full rank, then G_{ZF}=⁻¹. If \tilde{H} has does not have full rank, the two layers cannot be separated and the EVM requirement is failed.

Consequently, in order to use the pseudo-inverse when \tilde{H} does not have full rank, the following alternative solution may be utilized.

Solution 2: The zero-forcing receiver is defined as G_{ZF}=\tilde{H}⁺ where the singular value decomposition for \tilde{H} is given by

$$\tilde{H} = U \sum {V}^{H} ,$$

the pseudo-inverse \tilde{H}⁺ is defined as

$${\tilde{H}}^{+} = V {\sum }^{+} {U}^{H} ,$$

and Σ⁺ is derived from Σ by taking the inverse of the non-zero diagonal elements and leaving the zero elements in place.

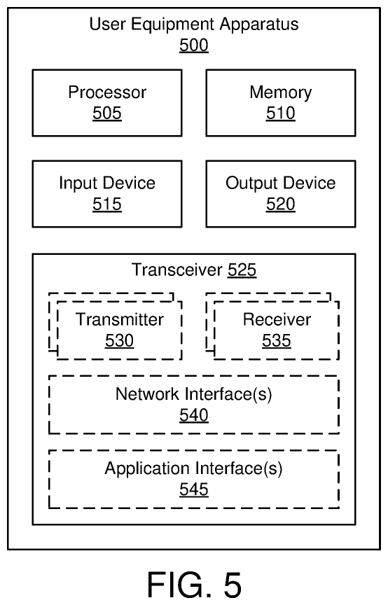

FIG. 5 depicts a user equipment apparatus 500 that may be used for MIMO EVM measurement using the pseudo-inverse, according to embodiments of the disclosure. In various embodiments, the user equipment apparatus 500 is used to implement one or more of the solutions described above. The user equipment apparatus 500 may be one embodiment of a transmitting device, such as the remote unit 105 and/or the UE 205, as described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 51. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above-described UE behaviors. In certain embodiments, the processor 505 may include an application processor (also known as “main processor”) which manages application-domain and operating system (“OS”) functions and a baseband processor (also known as “baseband radio processor”) which manages radio functions.

In various embodiments, the user equipment apparatus 500 operates as a transmitting device, such that the processor 505 generates a multiple-layer transmission signal for MIMO. Via the transceiver 525, the processor 505 transmits the generated multiple-layer transmission signal via a propagation channel that does not have full rank. For a square matrix, “full rank” means that the determinant of the matrix is non-zero and the matrix has an inverse (i.e., both rows and columns are linearly independent). For a non-square matrix having more columns than rows, “full rank” means that the rows of the matrix are linearly independent so that no row can be written as a combination of the other rows. For a non-square matrix having more rows than columns, “full rank” means that the columns of the matrix are linearly independent so that no column can be written as a combination of the other columns.

In other embodiments, the user equipment apparatus 500 may operate as an evaluator device, such that the processor 505 receives, via the transceiver 525, a multiple-layer transmission signal using a MIMO receiver. Moreover, the processor 505 calculates an EVM of the transmitter based on the multiple-layer transmission signal and using a pseudo-inverse of the channel matrix that is derived using a reciprocal of non-zero diagonal elements of a diagonal matrix of the singular values of the channel matrix. In certain embodiments, the transceiver 525 receives the multiple-layer signal using a MIMO receiver that comprises the pseudo-inverse of the channel matrix. As described above, the propagation channel may lack full rank.

In some embodiments, the MIMO layers of the multiple-layer transmission signal are not separable using the pseudo-inverse operation. In some embodiments, the propagation channel lacks full rank when the product of the effective channel matrix \tilde{H} multiplied by the pseudo-inverse of the effective channel matrix is not equal to the identity matrix I.

In some embodiments, the pseudo-inverse of the effective channel matrix is defined as

$${\tilde{H}}^{+} = V {\sum }^{+} {U}^{H}$$

where V is a unitary matrix, where Σ⁺ is derived from a diagonal matrix Σ by taking the reciprocal of the non-zero diagonal elements and leaving the zero elements in place, where the diagonal matrix Σ comprises diagonal elements that are real and non-negative, and where U^{H} is the Hermitian transpose of a unitary matrix U. In various embodiments, the MIMO receiver comprises a zero-forcing receiver defined as G_{ZF}=\tilde{H}⁺.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to MIMO EVM measurement using the pseudo-inverse. For example, the memory 510 may store parameters, configurations, and the like as described above. In certain embodiments, the memory 510 also stores program code and related data, such as an operating system or other controller algorithms operating on the user equipment apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least one transmitter 530 and at least one receiver 535. One or more transmitters 530 may be used to provide UL communication signals to a base unit 51, such as the UL transmissions described herein. Similarly, one or more receivers 535 may be used to receive DL communication signals from the base unit 51, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one or more common control signals or as modular transmitters 530 and receivers 535 implemented in the same hardware chip or in a multi-chip module.

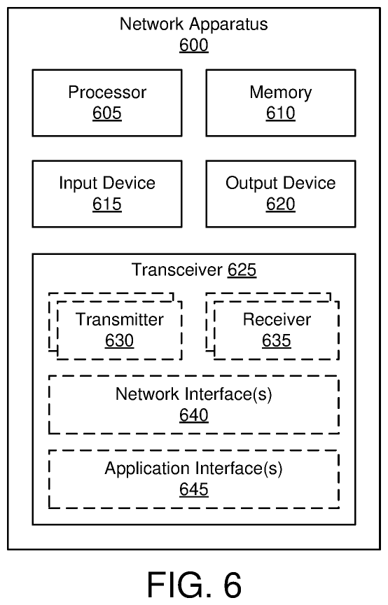

FIG. 6 depicts a network apparatus 600 that may be used for MIMO EVM measurement using the pseudo-inverse, according to embodiments of the disclosure. In one embodiment, the network apparatus 600 may be one implementation of an evaluator device, such as the test equipment 111, the base unit 121, the RAN node 210, the evaluator 320, and/or the evaluator device 410, as described above. Furthermore, the network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network apparatus 600 is a RAN node (e.g., gNB) that communicates with one or more UEs, as described herein. In such embodiments, the processor 605 controls the network apparatus 600 to perform the above-described RAN behaviors. When operating as a RAN node, the processor 605 may include an application processor (also known as “main processor”) which manages application-domain and operating system (“OS”) functions and a baseband processor (also known as “baseband radio processor”) which manages radio functions.

In various embodiments, the network apparatus 600 operates as an evaluator device, such that the processor 505 receives, via the transceiver 625, the processor 605 receives, from a transmitting device, a MIMO signal via a propagation channel that does not have full rank. Here, the multiple-layer MIMO signal is received using the MIMO receiver. In certain embodiments, the MIMO receiver comprises a zero-forcing receiver defined as G_{ZF}=\tilde{H}⁺.

In some embodiments, the MIMO layers of the multiple-layer MIMO signal are not separable using the pseudo-inverse operation. In some embodiments, the propagation channel does not have full rank so that the product of the effective channel matrix \tilde{H} multiplied by the pseudo-inverse of the effective channel matrix is not equal to the identity matrix I.

The processor 605 calculates an EVM of the transmitting device using a pseudo-inverse of the channel matrix that is derived using a reciprocal of non-zero diagonal elements of a diagonal matrix of the singular values of the channel matrix, where the MIMO receiver comprises the pseudo-inverse of the effective channel matrix. In some embodiments, the pseudo-inverse of the effective channel matrix is given by

$${\tilde{H}}^{+} = V {\sum }^{+} {U}^{H}$$

where V is a unitary matrix, Σ⁺ is derived from a diagonal matrix Σ by taking the reciprocal of the non-zero diagonal elements and leaving the zero elements in place, the diagonal matrix Σ comprises diagonal elements that are real and non-negative, and U^{H} is the Hermitian transpose of a unitary matrix U.

In other embodiments, the network apparatus 600 operates as a transmitting device, such that the processor 605 generates the multiple-layer transmission signal for MIMO. In such embodiments, via the transceiver 625, the processor 605 transmits the generated multiple-layer transmission signal via a propagation channel that does not have full rank.

The memory 610, in one embodiment, is a computer readable storage medium. In some embodiments, the memory 610 includes volatile computer storage media. For example, the memory 610 may include a RAM, including DRAM, SDRAM, and/or SRAM. In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to MIMO EVM measurement using the pseudo-inverse. For example, the memory 610 may store parameters, configurations, and the like, as described above. In certain embodiments, the memory 610 also stores program code and related data, such as an operating system or other controller algorithms operating on the network apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least one transmitter 630 and at least one receiver 635. One or more transmitters 630 may be used to communicate with the UE, as described herein. Similarly, one or more receivers 635 may be used to communicate with network functions in the PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

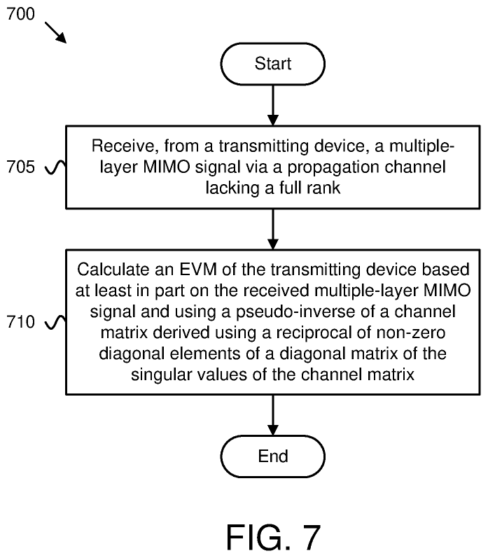

FIG. 7 depicts one embodiment of a method 700 for MIMO EVM measurement using the pseudo-inverse, according to embodiments of the disclosure. In various embodiments, the method 700 is performed by an evaluator device, such as the test equipment 111, the base unit 121, the UE 205, the RAN node 210, the evaluator 320, the evaluator device 410, and/or the network apparatus 600, described above. In some embodiments, the method 700 is performed by a processor, such as a microcontroller, a microprocessor, a CPU, a GPU, an auxiliary processing unit, a FPGA, or the like.

The method 700 includes receiving 705, from a transmitting device, a multiple-layer MIMO signal via a propagation channel lacking full rank. The method 700 includes calculating 710 an EVM of the transmitting device based at least in part on the received multiple-layer MIMO signal and using a pseudo-inverse of a channel matrix that is derived using a reciprocal of non-zero diagonal elements of a diagonal matrix of the singular values of the channel matrix. The method 700 ends.

Disclosed herein is a first apparatus for MIMO EVM measurement using the pseudo-inverse, according to embodiments of the disclosure. The first apparatus may be implemented by an evaluator device, such as the test equipment 111, the base unit 121, the UE 205, the RAN node 210, the evaluator 320, the evaluator device 410, the user equipment apparatus 500, and/or the network apparatus 600, described above. The first apparatus includes a MIMO receiver and a processor coupled to a memory, the processor configured to cause the first apparatus to: A) receive, from a second apparatus, a MIMO signal via a propagation channel that lacks full rank; and B) calculate an EVM of the second apparatus based at least in part of the received multiple-layer MIMO signal and using a pseudo-inverse of the channel matrix derived using a reciprocal of non-zero diagonal elements of a diagonal matrix of the singular values of the channel matrix.

In some embodiments, a set of MIMO layers of the multiple-layer MIMO signal are inseparable using the pseudo-inverse of the channel matrix. In some embodiments, the propagation channel that lacks full rank based at least in part on a result of a multiplication of an effective channel matrix \tilde{H} and the pseudo-inverse of the effective channel matrix being different than an identity matrix I.

In some embodiments, the pseudo-inverse of the effective channel matrix is defined as

$${\tilde{H}}^{+} = V {\sum }^{+} {U}^{H}$$

where V is a unitary matrix, where Σ⁺ is derived from a diagonal matrix Σ by obtaining the reciprocal of the non-zero diagonal elements and maintaining positions of the zero elements of the diagonal matrix, where the diagonal matrix Σ comprises diagonal elements comprising real and non-negative values, and where U^{H} comprises the Hermitian transpose of a unitary matrix U. In certain embodiments, the MIMO receiver comprises a zero-forcing receiver defined as G_{ZF}=\tilde{H}⁺.

In some embodiments, the first apparatus comprises a receiver (e.g., MIMO receiver) configured to cause the apparatus to receive, from the second apparatus, the multiple-layer MIMO signal, where the receiver comprises the pseudo-inverse of the channel matrix. In certain embodiments, the first apparatus comprises a remote unit (e.g., UE) and the second apparatus comprises a base station unit or a second remote unit. In other embodiments, the first apparatus comprises a base station unit and the second apparatus comprises a remote unit or a second base station unit.

Disclosed herein is a first method for MIMO EVM measurement using the pseudo-inverse, according to embodiments of the disclosure. The first method may be performed by an evaluator device, such as the test equipment 111, the base unit 121, the UE 205, the RAN node 210, the evaluator 320, the evaluator device 410, the user equipment apparatus 500, and/or the network apparatus 600, described above. The first method includes receiving, from a transmitting device, a multiple-layer MIMO signal via a propagation channel that lacks full rank; and calculating an EVM of the transmitting device based at least in part of the received multiple-layer MIMO signal and using a pseudo-inverse of the channel matrix derived using a reciprocal of non-zero diagonal elements of a diagonal matrix of the singular values of the channel matrix.

In some embodiments, a set of MIMO layers of the multiple-layer MIMO signal are inseparable using the pseudo-inverse of the channel matrix. In some embodiments, the propagation channel lacks full rank based at least in part on a result of a multiplication of an effective channel matrix \tilde{H} and the pseudo-inverse of the effective channel matrix being different than an identity matrix I.

In some embodiments, the pseudo-inverse of the effective channel matrix is given by

$${\tilde{H}}^{+} = V {\sum }^{+} {U}^{H}$$

where V is a unitary matrix, where Σ⁺ is derived from a diagonal matrix Σ by obtaining the reciprocal of the non-zero diagonal elements and maintaining positions of the zero elements of the diagonal matrix, where the diagonal matrix Σ comprises diagonal elements comprising real and non-negative values, and where U^{H} comprises the Hermitian transpose of a unitary matrix U. In certain embodiments, the MIMO receiver comprises a zero-forcing receiver defined as G_{ZF}=\tilde{H}⁺.

In some embodiments, the evaluator device comprises a receiver (e.g., MIMO receiver) configured to cause the apparatus to receive, from the transmitting device, the multiple-layer MIMO signal, where the receiver comprises the pseudo-inverse of the channel matrix. In certain embodiments, the evaluator device comprises a remote unit (e.g., UE) and the transmitting device comprises a base station unit or a second remote unit. In other embodiments, the evaluator device comprises a base station unit and the transmitting device comprises a remote unit or a second base station unit.

Disclosed herein is a system for MIMO EVM measurement using the pseudo-inverse, according to embodiments of the disclosure. The system includes a transmitting device and an evaluator device. The transmitting device may be an embodiment of the remote unit 105, the base unit 121, the UE 205, the RAN node 210, the transmitter 305, the transmitting device 405, the user equipment apparatus 500, and/or the network apparatus 600. The evaluator device may be an embodiment of the test equipment 111, the base unit 121, the UE 205, the RAN node 210, the evaluator 320, the evaluator device 410, the user equipment apparatus 500, and/or the network apparatus 600. The transmitting device is configured to generate a multiple-layer transmission signal for MIMO and to transmit the generated multiple-layer transmission signal via a propagation channel that lacks full rank. The evaluator device is configured to receive the multiple-layer transmission signal using a MIMO receiver and to calculate an EVM of the transmitter based on the multiple-layer transmission signal and using a pseudo-inverse of the channel matrix that is derived using a reciprocal of non-zero diagonal elements of a diagonal matrix of the singular values of the channel matrix, where the MIMO receiver comprises the pseudo-inverse of the channel matrix.

In some embodiments, the MIMO layers of the multiple-layer transmission signal are not separable using the pseudo-inverse operation. In some embodiments, the propagation channel lacks full rank when the product of the effective channel matrix \tilde{H} multiplied by the pseudo-inverse of the effective channel matrix is not equal to the identity matrix I.

In some embodiments, the pseudo-inverse of the effective channel matrix is defined as

$${\tilde{H}}^{+} = V {\sum }^{+} {U}^{H}$$

where V is a unitary matrix, where Σ⁺ is derived from a diagonal matrix Σ by taking the reciprocal of the non-zero diagonal elements and leaving the zero elements in place, where the diagonal matrix Σ comprises diagonal elements that are real and non-negative, and where U^{H} is the Hermitian transpose of a unitary matrix U. In various embodiments, the MIMO receiver comprises a zero-forcing receiver defined as G_{ZF}=\tilde{H}⁺.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a processor; and
a memory coupled to the processor, the processor configured to cause the apparatus to:
receive, from a second apparatus, a multiple-layer Multiple-Input, Multiple-Output (“MIMO”) signal via a propagation channel lacking a full rank; and
calculate an error vector magnitude (“EVM”) of the second apparatus based at least in part on the received multiple-layer MIMO signal and using a pseudo-inverse of a channel matrix derived using a reciprocal of non-zero diagonal elements of a diagonal matrix of the singular values of the channel matrix.

2. The apparatus of claim 1, wherein a set of MIMO layers of the multiple-layer MIMO signal are inseparable using the pseudo-inverse of the channel matrix.

3. The apparatus of claim 1, wherein the propagation channel lacks the full rank based at least in part on a result of a multiplication of an effective channel matrix \tilde{H} and a pseudo-inverse of the effective channel matrix \tilde{H} being different than an identity matrix I.

4. The apparatus of claim 3, wherein the pseudo-inverse of the effective channel matrix is given by
$${\tilde{H}}^{+} = V {\sum }^{+} {U}^{H}$$
where V is a unitary matrix, where Σ⁺ is derived from a diagonal matrix Σ by obtaining the reciprocal of the non-zero diagonal elements and maintaining positions of the zero elements of the diagonal matrix, where the diagonal matrix Σ comprises diagonal elements comprising real and non-negative values, and where U^{H} comprises the Hermitian transpose of a unitary matrix U.

5. The apparatus of claim 4, wherein a receiver of the apparatus comprises a zero-forcing receiver defined as G_{ZF}=\tilde{H}⁺.

6. The apparatus of claim 1, further comprising:
a receiver configured to cause the apparatus to:
receive, from the second apparatus, the multiple-layer MIMO signal, wherein the receiver comprises the pseudo-inverse of the channel matrix.

7. The apparatus of claim 1, wherein the apparatus comprises a remote unit and the second apparatus comprises a base unit or a second remote unit.

8. The apparatus of claim 1, wherein the apparatus comprises a base unit and the second apparatus comprises a remote unit or a second base unit.

9. A method at an evaluator device, the method comprising:
receiving, from a transmitting device, a multiple-layer Multiple-Input, Multiple-Output (“MIMO”) signal via a propagation channel lacking a full rank; and
calculating an error vector magnitude (“EVM”) of the transmitting device based at least in part on the received multiple-layer MIMO signal and using a pseudo-inverse of a channel matrix derived using a reciprocal of non-zero diagonal elements of a diagonal matrix of the singular values of the channel matrix.

10. The method of claim 9, wherein a set of MIMO layers of the multiple-layer MIMO signal are inseparable using the pseudo-inverse of the channel matrix.

11. The method of claim 9, wherein the propagation channel that lacks the full rank based at least in part on a result of a multiplication of an effective channel matrix \tilde{H} and a pseudo-inverse of the effective channel matrix being different than an identity matrix I.

12. The method of claim 11, wherein the pseudo-inverse of the effective channel matrix is given by
$${\tilde{H}}^{+} = V {\sum }^{+} {U}^{H}$$
where V is a unitary matrix, where Σ⁺ is derived from a diagonal matrix Σ by obtaining the reciprocal of the non-zero diagonal elements and maintaining positions of the zero elements of the diagonal matrix, where the diagonal matrix Σ comprises diagonal elements comprising real and non-negative values, and where U^{H} comprises the Hermitian transpose of a unitary matrix U.

13. The method of claim 12, wherein receiver of the evaluator device comprises a zero-forcing receiver defined as G_{ZF}=\tilde{H}⁺.

14. The method of claim 9, wherein the evaluator device comprises a receiver configured to cause the evaluator device to receive, from the transmitting device, the multiple-layer MIMO signal, wherein the receiver comprises the pseudo-inverse of the channel matrix.

15. The method of claim 9, wherein the transmitting device comprises a remote unit or a base unit.
